(19) United States
(12) Patent Application Publication
(10) Pub. No.: US 2011/0138917 A1
(43) Pub. Date: Jun. 16, 2011

(54) Portable ultrasonic instrument used to distinguish among pig meat and meats of other origin

(75) Inventors: Awad Al-Khalaf, Sharjah (AE); Hussein Elmehdi, Sharjah (AE); Ibrahim Mostafa Kamel, Sharjah (AE)

(73) Assignees: Awad Al-Khalaf, Sharjah (AE); Hussein Elmehdi, Sharjah (AE); Ibrahim Mostafa Kamel, Sharjah (AE)

(21) Appl. No.: 12/638,990

(22) Filed: Dec. 16, 2009

(51) Int. Cl. G01N 29/14

(52) U.S. Cl. 73/587

(57) ABSTRACT

The technology is based on subjecting the meat sample to an ultrasonic signal, of a specific frequency, and detects its reflected component. The detected signal will be analyzed using a fully developed and commercially available digital signal processing techniques to extracted ultrasonic parameters that can be directly related to elastic properties of the sample under investigation (piece of meat) and hence used to distinguish among the meats in question.

### DETAILED DESCRIPTION OF THE INVENTION

Since there have been several studies that have utilized ultrasound to detect and characterize quality of meats, the technology will concentrate on developing a prototype composed of an ultrasonic probe that will act as the generator and receiver of the ultrasonic signal. The sample under investigation will be subjected to this ultrasonic signal, with multiple frequencies, and once the reflected component is received at the probe, it is transmitted to the computer for subsequent analysis to extract the ultrasonic parameters associated with that specific sample. These parameters will be compared to a set of parameters available in a table, which will be compiled by the inventors, to identify meat piece in question.

The parameters are used to characterize the type of meat under consideration and build a computer-based classifier. Data collected from the training (control) set will be transformed to an appropriate space then will be used to tune the system to recognize an unknown sample of meat. We will use a training set that represents the different types of meats under consideration. The same parameters are collected, from an unknown meat sample, using the proposed device. The measured data are subjected to the same pre-processing steps as above then the classifier is used to determine the type of the meat.

The most important set of parameters are those used to characterize the acoustical properties of the pig meat, which include the ultrasonic velocity and attenuation coefficient. These two parameters are related to the elastic properties of the material in general, specifically the bulk modulus, which is related to the square of the ultrasonic velocity and the density. Since the focus is to identify whether the meat is of a pig origin or not, the technology will be provided a full quantitative description of parameter related to meats used in the targeted community; plus that of pig origin. This will provide the user with a quick and easy comparison between the measured parameters to those available on the comparison table and will be able to quickly decide on meat he is being sold.

What is claimed is:

1. A non-invasive device for grading animal carcass comprising of a pulser/receiver is used to transmit the electromagnetic (EM) signal, which is used to excite an ultrasonic transducer operating at frequency larger than 20 KHz and less than 5 MHz. The generated ultrasonic signal propagates through the sample and reflected back at the opposite side of the sample. The transducer will act as a receiver that converts the reflected ultrasonic signal back to an EM signal, which will be processed in the pulser/receiver.

2. The detected signal will be in the form of spectrum comprised of several echoes that carry the signature of the specific meat sample under investigation. The main parameters include signal amplitude and transit time, the later of which is defined as the time taken for the ultrasonic signal to propagate through the sample. These two parameters will be processed by a smart unit to extract a signature that is specific to the type of meat. The extracted signature is a function of the propagation velocity and the relative attenuation coefficient.

3. The device of claims 1 and 2 includes a digital processor, which:
Takes the ultrasonic spectra for the sample under investigation and the background (reference) spectrum;
Step i is repeated several times and the average spectrum is determined using an advanced signal processing technique;
The reference spectrum is subtracted from the average spectrum. The resulting spectrum is used to determine the velocity and attenuation coefficient for the sample under investigation;
The processor contains a bank of ultrasonic spectra and the corresponding velocity and attenuation coefficient values for a wide range of variety of meats; and
Through a pattern recognition scheme, the device compares the collected spectrum and associated velocity and attenuation values to a bank of spectra and determines the variety of the meat.
